(19) United States
(12) Patent Application Publication
(10) Pub. No.: US 2018/0038102 A1
(43) Pub. Date: Feb. 8, 2018

(54) Partition Having Increased Fixing Strength

(71) Applicant: Saint-Gobain Placo SAS, Suresnes (FR)

(72) Inventors: Nicholas Jones, Melton Mowbray (GB); Adam Richardson, Coventry (GB); Jan Rideout, Rothley (GB)

(21) Appl. No.: 15/553,282

(22) PCT Filed: Feb. 18, 2016
(86) PCT No.: PCT/GB2016/050409

§ 371 Date: Aug. 24, 2017

(30) Foreign Application Priority Data
Feb. 26, 2015 (GB) 1503254.3

(51) Int. Cl. E04C 2/06; B32B 13/02; C04B 41/71; C04B 24/38; C04B 28/14; C04B 41/45; E04C 2/04; C04B 14/42

(52) U.S. Cl. CPC E04C 2/06; E04C 2/043; B32B 13/02; C04B 14/42; C04B 24/383; C04B 28/14; C04B 41/4503; C04B 41/71; B32B 2262/101; B32B 2419/00; C04B 2111/0062

(57) ABSTRACT

A partition is adapted to support a fixture and has a front surface to which the fixture may be affixed and a back surface that faces away from the fixture. The partition comprises a plasterboard and a reinforcing board, the reinforcing board being located between the plasterboard and the front surface, and the plasterboard comprising at least 1 wt % fibre and at least 1 wt % polymer is additive.

The present invention relates to partitions having increased fixing strength and to panels for use therein.

Gypsum plasterboard is commonly used to provide partitions within buildings. Its advantages for this application include the fact that it is light and quick to install.

It is desirable for plasterboard to be strong enough to support fixtures (e.g. sinks, televisions, radiators, fire extinguishers, shelves and any other item that requires attachment to the board), such that fixing means (for example, screws) are securely retained in the board.

WO2014/188168 discloses the addition of starch and/or fibres to the gypsum matrix in order to improve fixing strength.

It is desirable to improve fixing strength still further.

Surprisingly, it has been found that when a gypsum plasterboard containing fibres and starch is used in conjunction with a reinforcing board, to provide a dual layer panel, the fixing strength can be improved still further. The reinforcing board is for positioning between the plasterboard and the fixture. It is thought that the reinforcing board helps to reduce the deflection of the plasterboard when the panel is used to support fixtures, thus helping to increase the force required to remove fixtures such as screws.

Therefore, in a first aspect, the present invention may provide a partition that is adapted to support a fixture, the partition having a front surface for affixing a fixture thereto and a back surface that is for facing away from the fixture, the partition comprising a plasterboard and a reinforcing board, the reinforcing board being located between the plasterboard and the front surface, and the plasterboard comprising at least 1 wt % fibre and at least 1 wt % polymeric additive.

Typically, the front surface of the partition is provided by one of the faces of the reinforcing board.

Typically, the polymeric additive is a starch. In general, the fibres are glass fibres.

Preferably, the plasterboard comprises at least 2 wt % fibre.

Preferably, the plasterboard comprises at least 3 wt %, preferably at least 5 wt % of the polymeric additive.

In general, the plasterboard is provided with a liner on each face, for example, a paper liner or a glass fibre mat. In such cases, the plasterboard is preferably symmetrical, that is, both faces are provided with the same type of liner.

In certain embodiments, the plasterboard and the reinforcing board are glued together. In other embodiments, the plasterboard and the reinforcing board are connected via double sided glue tape or double sided bonding tape. Such tapes preferably comprise a thin adhesive layer applied to opposing sides of a carrier material.

In such cases, the glue is preferably a viscoelastic glue.

In other embodiments, the plasterboard and the reinforcing board are secured to each other by means of mechanical fixings, such as screws.

In such cases, the reinforcing board may be offset relative to the plasterboard in the plane of the partition.

In fact, it has been found that due to the high fixing strength of the plasterboard, the reinforcing board may be supported entirely by the plasterboard, so that the reinforcing board does not need to be affixed directly to the frame that supports the partition. This allows for considerable flexibility in the way the partition is configured with regards to the degree of offset between the reinforcing board and the plasterboard.

The reinforcing board may be offset relative to the plasterboard also in the embodiments for which the plasterboard and reinforcing board are glued together or bonded via double sided bonding tape. In such embodiments, it is also possible that the reinforcing board is supported entirely by the plasterboard, so that the reinforcing board does not need to be affixed directly to the frame that supports the partition.

Typically, the reinforcing board has a thickness in the range 6-19 mm.

Preferably, the reinforcing board comprises gypsum as a major component. In such cases, the partition comprises a first plasterboard, whose function is to retain a screw, and a second, reinforcing plasterboard, whose function is to limit deflection of the first plasterboard when a pull-out force is applied to the screw.

In the case that the reinforcing board is a plasterboard, the reinforcing board is typically provided with a liner on each face, for example, a paper liner or a glass fibre mat. In such cases, the reinforcing board is preferably symmetrical, that is, both faces are provided with the same type of liner.

In other embodiments, the reinforcing board may comprise a hardboard that is provided with a layer of padding. Preferably, in this case, the hardboard is located adjacent the plasterboard, while the layer of padding provides the front surface of the board.

Dual layer panels comprising two plasterboard layers are known e.g. for improving acoustic properties. However, since the plasterboards of these panels do not comprise fibre and polymeric additives in the amounts specified by the present invention, the plasterboards are not able to retain screw fixings to the same extent, and so the effect of the present invention (that is, the tendency of the first plasterboard to deflect when a pull-out force is applied to a screw that is affixed therein, and the tendency of the reinforcing board to inhibit such deflection) is not observed.

Most preferably, the reinforcing board comprises at least1 wt % fibres and 1 wt % polymeric additive. Typically, the reinforcing board has the same composition as the plasterboard.

Typically, the presence of the reinforcing board has the effect of increasing the ability of the partition to retain a screw by 1.5 times, preferably 2 times, more preferably 2.5 times, relative to the plasterboard alone.

Typically, the presence of the reinforcing board has the effect of increasing the screw pull-out strength of the partition by 1.5 times, preferably 2 times, more preferably 2.5 times, relative to the plasterboard alone.

Typically, the presence of the reinforcing board has the effect of increasing the screw pull-out strength of the partition to at least 1000 N, preferably at least 1200N, more preferably at least 1400 N.

Typically, the presence of the reinforcing board has the effect of increasing the screw pull-out strength of the partition after cyclic loading by 1.5 times, preferably 2 times, more preferably 2.5 times, relative to the plasterboard alone.

Typically, the presence of the reinforcing board has the effect of increasing the screw pull-out strength of the partition in relation to a re-fitted screw by 1.5 times, preferably 2 times, more preferably 2.5 times, relative to the plasterboard alone.

Typically, the presence of the reinforcing board has the effect of increasing the ability of the partition to retain a screw under eccentric loading by 1.5 times, preferably 2 times, more preferably 2.5 times relative to the plasterboard alone.

In a second aspect, the present invention may provide a panel comprising a plasterboard and a reinforcing board, the plasterboard being glued face-to-face with the reinforcing board, the plasterboard comprising at least 1 wt % fibre and at least 1 wt % of a polymeric additive.

Typically the glue is a viscoelastic glue.

The plasterboard and the reinforcing board may respectively have one or more of the properties of the plasterboard and the reinforcing board of the first aspect of the invention.

The invention will now be described by way of example only.

### COMPARATIVE EXAMPLE 1

A gypsum plasterboard containing 2 wt % amount fibres and 6 wt % amount starch.

EXAMPLE 1

A dual layer board formed from two plasterboards according to Comparative Example 1, joined together on their faces.

Heavyweight anchorage (washbasin) eccentric downward loading test

Panels were subjected to a heavyweight anchorage (washbasin) eccentric downward loading test following the methodology set out in BS5234: Part 2: 1992—Annex K.

Tests were carried out at a temperature of 15-20° C. and a relative humidity of 50-60%.

The load was supported by a bracket held by five general purpose screws.

The results are given in Table 1.

TABLE 1

| | Load at failure (bracket becomes detached) |
|---|---|
| Comparative Example 1 | 350N |
| Example 1 | 912N |

Screw Pull-Out Strength

Screw pull-out tests were carried out on samples measuring 100 mm by 100 mm that had been conditioned at a temperature of 23° C. and a relative humidity of 50%. A 50 mm single thread wood screw was inserted into the sample, passing through a metal loop positioned on the surface of the sample. The screw was tightened to a torque of 100 cNm.

The specimen was then mounted in a Zwick Universal Testing Machine and a 10N pre-load applied to the screw along the axis of the screw. Subsequently, the load was increased by setting a constant cross-head speed of 10 mm/minute until pull out was achieved.

The results are given in Table 2, which shows the average taken from 5 samples.

TABLE 2

| | Screw pull-out strength (N) |
|---|---|
| Comparative Example 1 | 643 |
| Example 1 | 1636 |

Screw Pull-Out Strength After Cyclic Loading

Screw pull-out tests were carried out as described above, except that after the step of applying a pre-load to the screw and before the step of increasing the load by setting a constant cross-head speed of 10 mm/minute until pull out was achieved, the load applied to the screw was cycled between 10N and 500N for 100 times.

The results are given in Table 3, which shows the average taken from 5 samples.

TABLE 3

| | Screw pull-out strength (N) |
|---|---|
| Comparative Example 1 | 635 |
| Example 1 | 2023 |

Screw Pull-Out Strength of Re-Fitted Screw

Screw pull-out tests were carried out as described above, except that before the step of mounting the sample in the Universal Testing Machine, the screw was removed, reinserted into the sample and tightened to a torque of 100 cNm.

The results are given in Table 4, which shows the average taken from five samples.

TABLE 4

| | Screw pull-out strength |
|---|---|
| Comparative Example 1 | 517 |
| Example 1 | 1844 |

1. A partition that is adapted to support a fixture, the partition having a front surface that is for affixing a fixture thereto and a back surface that is for facing away from the fixture, the partition comprising a plasterboard and a reinforcing board, the reinforcing board being located between the plasterboard and the front surface, and the plasterboard comprising at least 1 wt % fibre and at least 1 wt % polymeric additive.

2. A partition according to claim 1, characterised in that the ability of the partition to retain a screw is 1.5 times greater than that of the plasterboard alone.

3. A partition according to claim 2 having a screw pull-out strength greater than 1000 N.

4. A partition according to claim 1, wherein the plasterboard and the reinforcing board are glued together.

5. A partition according to claim 4, wherein the glue is a viscoelastic glue.

6. A partition according to claim 1, wherein the plasterboard and the reinforcing board are connected with double sided glue tape.

7. A partition according to claim 1, wherein the plasterboard and the reinforcing board are secured to each other by means of mechanical fixings.

8. A partition according to claim 7, wherein the plasterboard and the reinforcing board are secured to each other by means of screw fixings.

9. A partition according to claim 7, wherein the reinforcing board is offset relative to the plasterboard in the plane of the partition.

10. A partition according to claim 7, wherein the reinforcing board has a thickness in the range 6-19 mm.

11. A partition according to claim 7, wherein the reinforcing board comprises gypsum as a major component.

12. A partition according to claim 11, wherein the reinforcing board comprises at least 1 wt % fibres and at least 1 wt % of a polymeric additive.

13. A partition according to claim 11, wherein the plasterboard comprises at least 2 wt % fibre.

14. A partition according to claim 11, wherein the plasterboard contains at least 3 wt % polymeric additive, preferably at least 5 wt % polymeric additive.

15. A partition according to claim 11, wherein the fibres in the plasterboard are glass fibres.

16. A partition according to claim 11, wherein the polymeric additive is a starch.
